(19) United States
(12) Patent Application Publication
(10) Pub. No.: US 2025/0088957 A1
(43) Pub. Date: Mar. 13, 2025

(54) COEXISTENCE OF DIFFERENT NETWORK ARCHITECTURES FOR A SATELLITE

(71) Applicant: QUALCOMM Incorporated, San Diego, CA (US)

(72) Inventors: Toru UCHINO, Zushi-shi (JP); Bharat SHRESTHA, San Diego, CA (US); Umesh PHUYAL, San Diego, CA (US); Geetha Priya RAJENDRAN, Bangalore (IN); Prasad Reddy KADIRI, San Diego, CA (US)

(21) Appl. No.: 18/463,438

(22) Filed: Sep. 8, 2023

(51) Int. Cl. H04W 48/20; H04W 74/08; H04W 76/10

(52) U.S. Cl. CPC H04W 48/20; H04W 74/0833; H04W 76/10; H04W 84/042; H04W 84/06

(57) ABSTRACT

Various aspects of the present disclosure generally relate to wireless communication. In some aspects, a user equipment (UE) may receive cell characteristic information of multiple network nodes associated with different network architectures. The UE may select a network node, from the multiple network nodes, based at least in part on a mapping rule and the cell characteristic information, wherein the mapping rule is associated with UE information and cell or network information. The UE may transmit a random access channel (RACH) message to establish a connection with the network node. Numerous other aspects are described.

### FIELD OF THE DISCLOSURE

Aspects of the present disclosure generally relate to wireless communication and to techniques and apparatuses for coexistence of different network architectures on satellites.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes memory; and one or more processors coupled to the memory, the one or more processors configured to cause the UE to: receive cell characteristic information of multiple network nodes associated with different network architectures; select a network node, from the multiple network nodes, based at least in part on a mapping rule and the cell characteristic information, wherein the mapping rule is associated with UE information and cell or network information; and transmit a random access channel (RACH) message to establish a connection with the network node.

In some implementations, an apparatus for wireless communication at a network node associated with a satellite includes memory; and one or more processors coupled to the memory, the one or more processors configured to cause the network node to: receive, from a UE, a message; and route, based at least in part on information associated with the message, the message to an upper layer node associated with a network architecture.

In some implementations, a method of wireless communication performed by a UE includes receiving cell characteristic information of multiple network nodes associated with different network architectures; selecting a network node, from the multiple network nodes, based at least in part on a mapping rule and the cell characteristic information, wherein the mapping rule is associated with UE information and cell or network information; and transmitting a RACH message to establish a connection with the network node.

In some implementations, a method of wireless communication performed by a network node associated with a satellite includes receiving, from a UE, a message; and routing, based at least in part on information associated with the message, the message to an upper layer node associated with a network architecture.

In some implementations, a non-transitory computer-readable medium storing a set of instructions for wireless communication includes one or more instructions that, when executed by one or more processors of a UE, cause the UE to: receive cell characteristic information of multiple network nodes associated with different network architectures; select a network node, from the multiple network nodes, based at least in part on a mapping rule and the cell characteristic information, wherein the mapping rule is associated with UE information and cell or network information; and transmit a RACH message to establish a connection with the network node.

In some implementations, a non-transitory computer-readable medium storing a set of instructions for wireless communication includes one or more instructions that, when executed by one or more processors of a network node, cause the network node to: receive, from a UE, a message; and route, based at least in part on information associated with the message, the message to an upper layer node associated with a network architecture.

In some implementations, an apparatus for wireless communication includes means for receiving cell characteristic information of multiple network nodes associated with different network architectures; means for selecting a network node, from the multiple network nodes, based at least in part on a mapping rule and the cell characteristic information, wherein the mapping rule is associated with apparatus information and cell or network information; and means for transmitting a RACH message to establish a connection with the network node.

In some implementations, an apparatus for wireless communication includes means for receiving, from a UE, a message; and means for routing, based at least in part on information associated with the message, the message to an upper layer node associated with a network architecture.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a non-terrestrial network (NTN)-based Next Generation radio access network (NG-RAN) architecture, in accordance with the present disclosure.

FIG. 5 is a diagram illustrating an example of an NTN-based NG-RAN architecture, in accordance with the present disclosure.

FIG. 6 is a diagram illustrating an example of an NTN-based NG-RAN architecture, in accordance with the present disclosure.

FIG. 7 is a diagram illustrating an example of coexistence of different NTN architectures on a satellite, in accordance with the present disclosure.

FIG. 8 is a diagram illustrating an example of coexistence of multiple NTN architectures, in accordance with the present disclosure.

FIGS. 9-15 are diagrams illustrating examples associated with coexistence of different NTN architectures on satellites, in accordance with the present disclosure.

FIGS. 16-17 are diagrams illustrating example processes associated with coexistence of different NTN architectures on satellites, in accordance with the present disclosure.

FIGS. 18-19 are diagrams of example apparatuses for wireless communication, in accordance with the present disclosure.

### DETAILED DESCRIPTION

Multiple non-terrestrial network (NTN) architectures may be installed on a satellite. The multiple NTN architectures may include a gNB (or gNB distributed unit (gNB-DU)) processed payload architecture or a bent-pipe architecture. When the multiple NTN architectures are installed on the satellite, a user equipment (UE) may need to connect to a suitable NTN architecture. For example, when the UE requests a particular service (e.g., store and forward), then the UE should connect to the gNB (or gNB-DU) processed payload architecture. On the other hand, when an onboard gNB, gNB central unit (gNB-CU), and/or user plane function (UPF) is congested, the UE should connect to the bent-pipe architecture. Network handling may allow a network to change the gNB and/or the UPF for the UE via a handover or via a release with redirection. However, such network handling may take additional time to establish a connection with a suitable NTN architecture, which may be based at least in part on a longer over-the-air (OTA) delay in an NTN environment as compared to a non-NTN environment. Thus, network handling in this scenario may degrade an overall system performance.

Various aspects relate generally to coexistence of different NTN architectures on satellites. Some aspects more specifically relate to connecting a UE to a suitable NTN architecture when multiple NTN architectures are installed on a satellite. In some examples, a UE may receive cell characteristic information of multiple network nodes associated with different network architectures, such as different NTN architectures. The UE may select a network node, from the multiple network nodes, based at least in part on a mapping rule and the cell characteristic information. The mapping rule may be associated with UE information and cell or network information. The UE may transmit, to the network node, a RACH message to establish a connection with the network node. Alternatively, a network node, such as a routing node, may receive a message from a UE. The network node may route, based at least in part on information associated with the message, the message to an upper layer node associated with a network architecture, such as an NTN architecture. As a result, the UE may be able to connect to a suitable NTN architecture. In other words, the UE may connect to a node (e.g., a network node or an upper layer node, such as a distributed unit (DU), central unit (CU), and/or core network (CN)) that is associated with the suitable NTN architecture, which may be useful when a satellite installs multiple NTN architectures. The node associated with the suitable NTN architecture may be selected by the UE itself or another node, such as the routing node. For example, the UE may connect to a node associated with a gNB (or gNB-DU) processed payload architecture or a node associated with a bent-pipe architecture, which may be based at least in part on a particular service used by other UE and/or other factors (e.g., congestion).

Particular aspects of the subject matter described in this disclosure can be implemented to realize one or more of the following potential advantages. In some examples, by connecting the UE to the suitable NTN architecture when multiple NTN architectures are installed on the satellite, the described techniques can be used to selecting the suitable NTN architecture with a reduced OTA delay. The UE may connect to the particular service using an appropriate NTN architecture, which may be based at least in part on the service and/or other factors (e.g., congestion), thereby improving an overall system performance. The UE may be able to connect to the suitable NTN architecture without a network handling (e.g., changing a gNB and/or UPF via a handover or a release with redirection), which may improve the overall system performance because the network handling may be associated with higher OTA delays.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

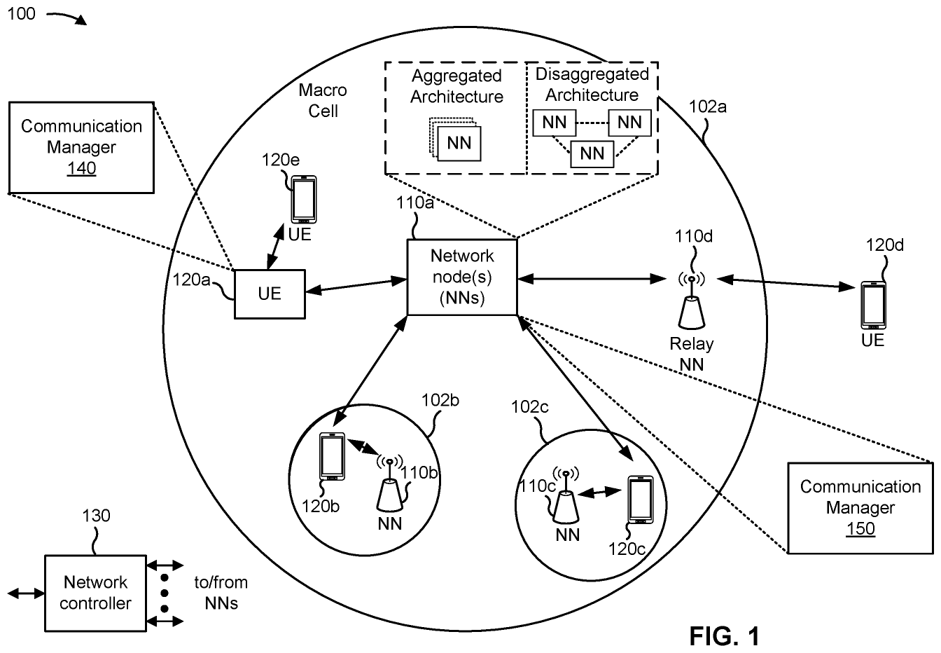

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more CUs, one or more DUs, or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive cell characteristic information of multiple network nodes associated with different network architectures; select a network node, from the multiple network nodes, based at least in part on a mapping rule and the cell characteristic information, wherein the mapping rule is associated with UE information and cell or network information; and transmit a RACH message to establish a connection with the network node. Additionally, or alternatively, the communication manager 140 may perform one or more other operations described herein.

In some aspects, a network node (e.g., the network node 110) may include a communication manager 150. As described in more detail elsewhere herein, the communication manager 150 may receive, from a UE, a message; and route, based at least in part on information associated with the message, the message to an upper layer node associated with a network architecture. Additionally, or alternatively, the communication manager 150 may perform one or more other operations described herein.

As indicated above, FIG. 1 is provided as an example. Other examples may differ from what is described with regard to FIG. 1.

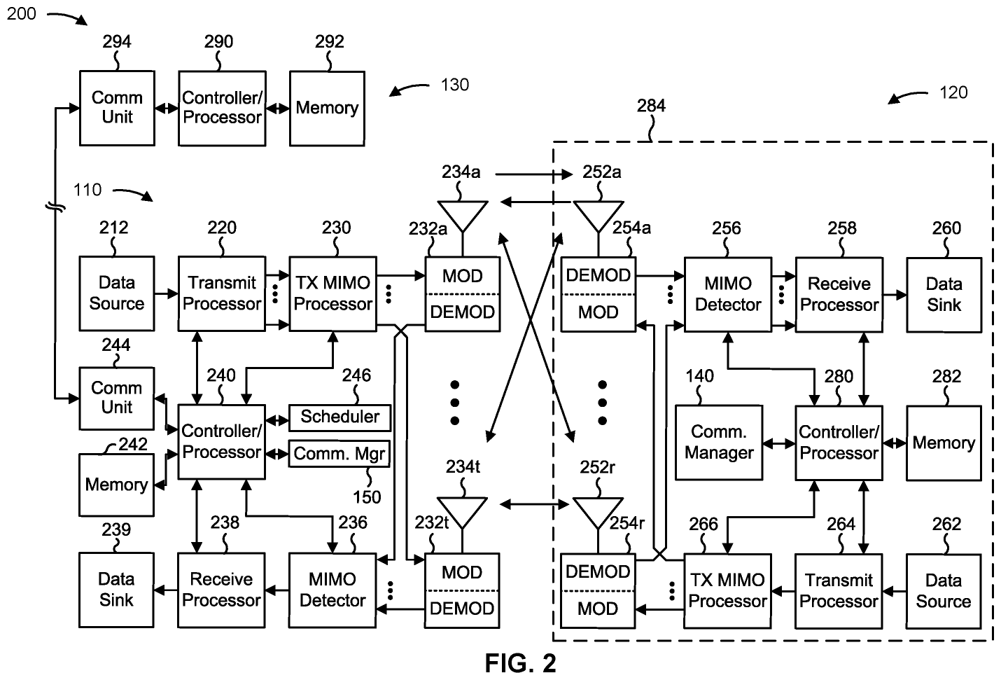

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

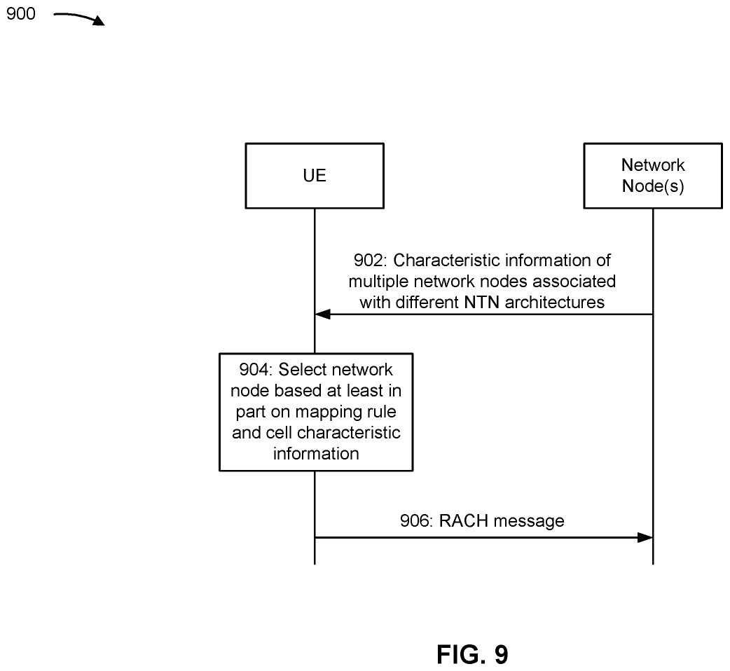

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9-19).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9-19).

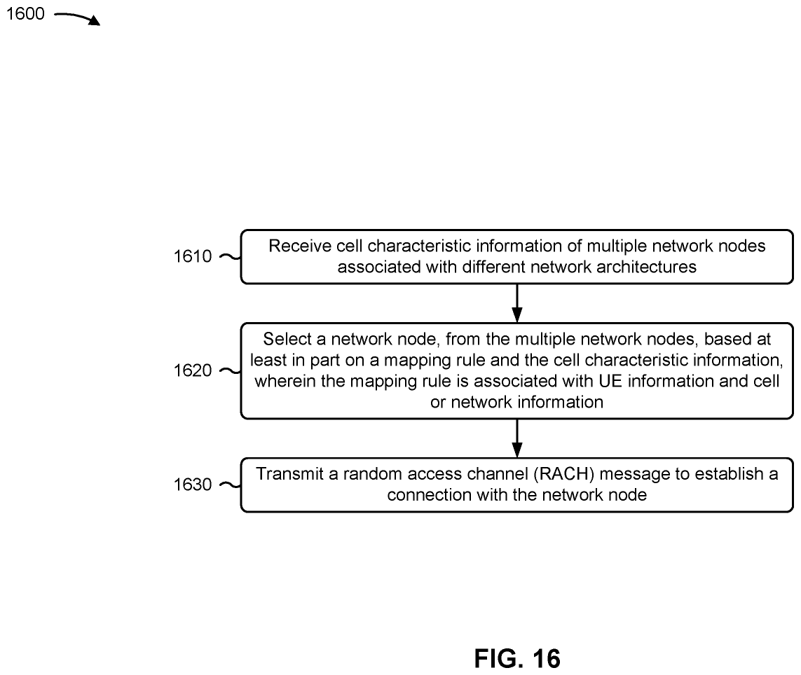

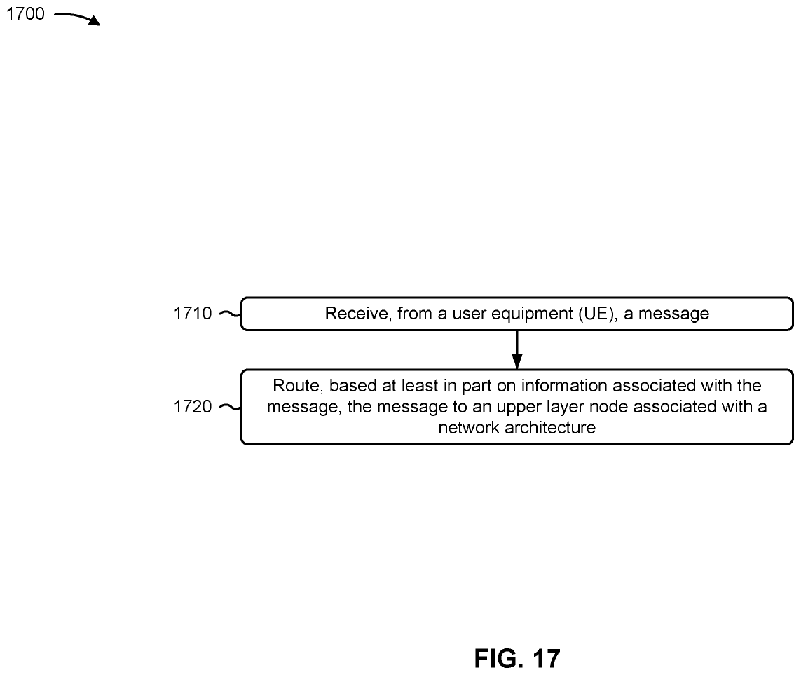

The controller/processor 240 of the network node 110, the controller/processor 280 of the UE 120, and/or any other component(s) of FIG. 2 may perform one or more techniques associated with coexistence of different network architectures on satellites, as described in more detail elsewhere herein. For example, the controller/processor 240 of the network node 110, the controller/processor 280 of the UE 120, and/or any other component(s) of FIG. 2 may perform or direct operations of, for example, process 1600 of FIG. 16, process 1700 of FIG. 17, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1600 of FIG. 16, process 1700 of FIG. 17, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving cell characteristic information of multiple network nodes associated with different network architectures; means for selecting a network node, from the multiple network nodes, based at least in part on a mapping rule and the cell characteristic information, wherein the mapping rule is associated with UE information and cell or network information; and/or means for transmitting a RACH message to establish a connection with the network node. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from a UE, a message; and/or means for routing, based at least in part on information associated with the message, the message to an upper layer node associated with a network architecture. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, May be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

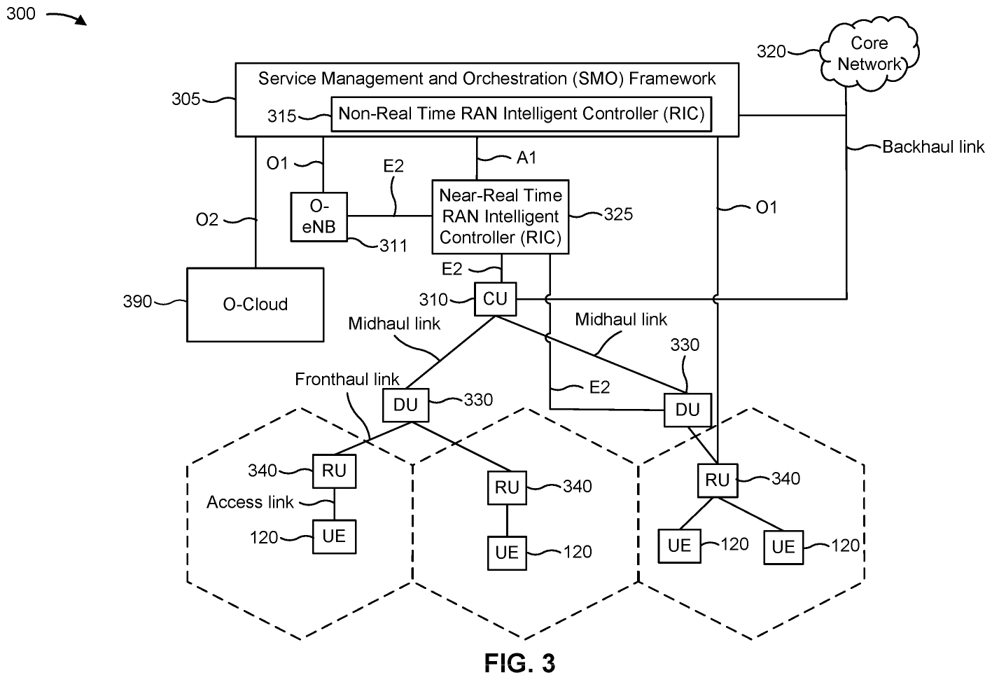

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle OTA communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

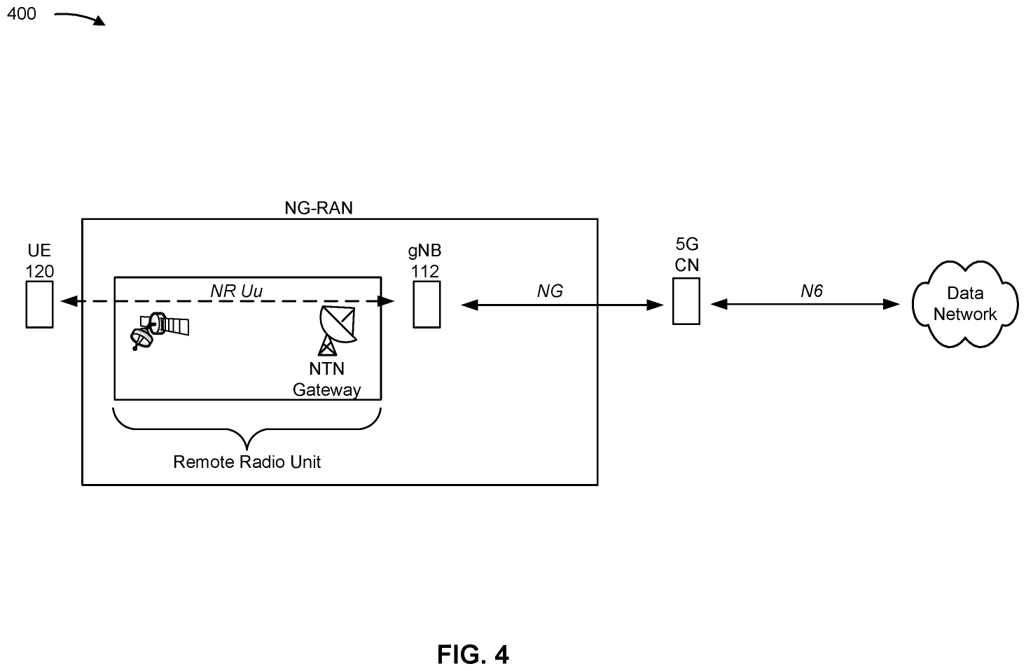

FIG. 4 is a diagram illustrating an example 400 of an NTN-based Next Generation radio access network (NG-RAN) architecture, in accordance with the present disclosure.

As shown in FIG. 4, a transparent satellite based NG-RAN architecture may be defined. A UE 120 may connect to a gNB 112 via a satellite and an NTN gateway. The satellite and the NTN gateway may be associated with a remote radio head. The satellite may be associated with a bent-pipe architecture, where a “bent pipe” may redirect user data to a ground gNB using an NR protocol. The UE 120 may connect to the gNB 112 via an NR Uu interface. The satellite, the NTN gateway, and the gNB 112 may be associated with an NG-RAN. The gNB 112 may connect to a 5G CN via a Next Generation (NG) interface. The 5G CN may connect to a data network via an N6 interface.

In this example, a satellite payload may implement frequency conversion and a radio frequency amplifier in both an uplink and downlink direction. The satellite may correspond to an analog RF repeater. The satellite may repeat an NR-Uu radio interface from a feeder link (between the NTN gateway and the satellite) to a service link (between the satellite and the UE 120) and vice versa. A satellite radio interface (SRI) on the feeder link may be the NR Uu interface. In other words, the satellite may not terminate the NR-Uu interface. The NTN gateway may support all necessary functions to forward the signal of the NR-Uu interface. Different transparent satellites may be connected to the same gNB on the ground.

As indicated above, FIG. 4 is provided as an example. Other examples may differ from what is described with regard to FIG. 4.

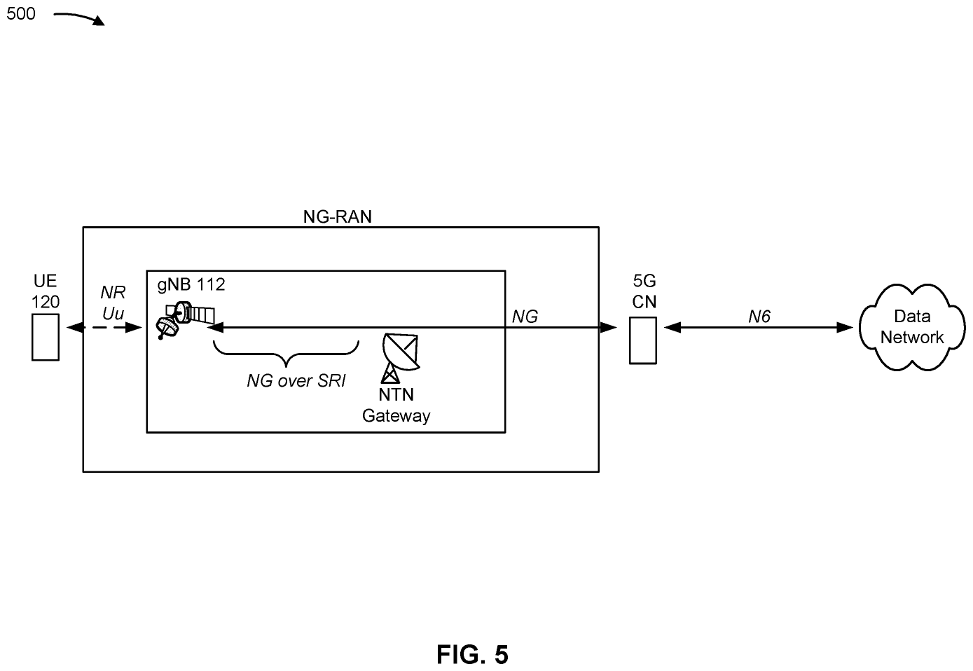

FIG. 5 is a diagram illustrating an example 500 of an NTN-based NG-RAN architecture, in accordance with the present disclosure.

As shown in FIG. 5, a regenerative satellite based NG-RAN architecture may be defined. The regenerative satellite based NG-RAN architecture may be based at least in part on a gNB processed payload architecture. The regenerative satellite may be associated with a fully functional gNB. A UE 120 may connect to a gNB 112 via an NR Uu interface. The gNB 112 may be associated with a satellite and an NTN gateway. The satellite and the NTN gateway may connect via an NG over SRI. The gNB 112 may be associated with an NG-RAN. The gNB 112 may connect to a 5G CN via an NG interface. The 5G CN may connect to a data network via an N6 interface.

In this example, a satellite payload may implement a regeneration of signals received from Earth. An NR-Uu radio interface may be associated with a service link between the UE 120 and the satellite. An SRI may be associated with a feeder link between the NTN gateway and the satellite. The SRI may be a transport link between the NTN gateway and the satellite. In some cases, a satellite payload may provide inter-satellite links (ISLs) between satellites. An ISL may be a transport link between satellites. The ISL may be a radio interface or an optical interface. The NTN gateway may be a transport network layer node, and may support all necessary transport protocols. A DU and a CU may be on board a satellite.

As indicated above, FIG. 5 is provided as an example. Other examples may differ from what is described with regard to FIG. 5.

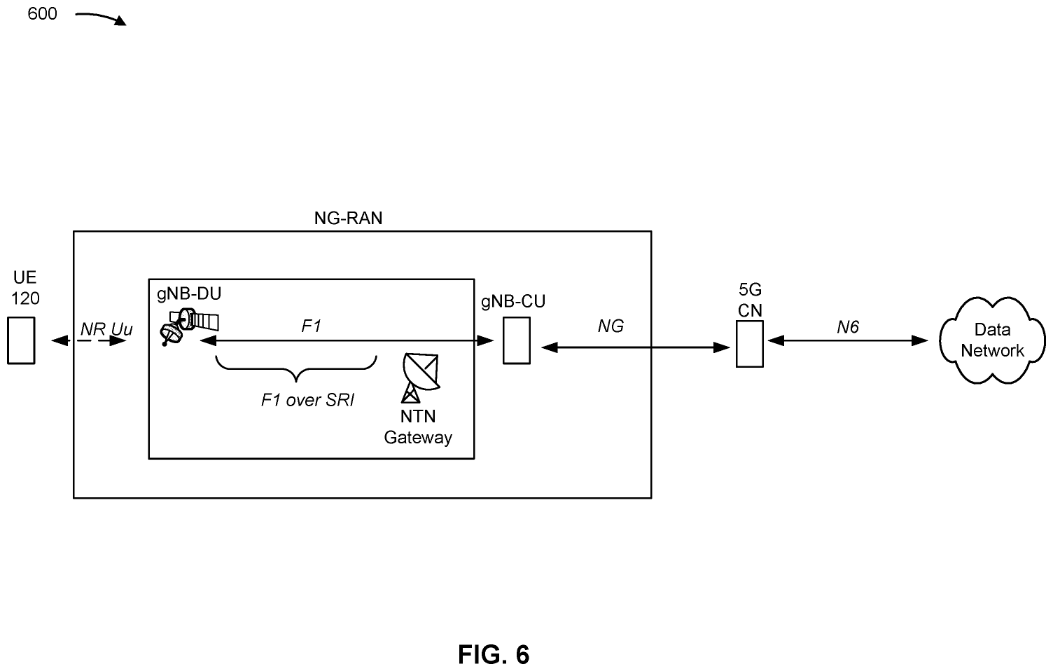

FIG. 6 is a diagram illustrating an example 600 of an NTN-based NG-RAN architecture, in accordance with the present disclosure.

As shown in FIG. 6, a regenerative satellite based NG-RAN architecture may be defined. The regenerative satellite based NG-RAN architecture may be based at least in part on a gNB-DU processed payload architecture. The regenerative satellite may be associated with a full functional gNB. A UE 120 may connect to a gNB-DU via an NR Uu interface. The gNB-DU may be associated with a satellite and an NTN gateway. The satellite and the NTN gateway may connect via an NG over SRI. The gNB-DU may connect to a gNB-CU. The gNB-DU and the gNB-CU may be associated with an NG-RAN. The gNB-CU may connect to a 5G CN an NG interface. The 5G CN may connect to a data network via an N6 interface.

In this example, a satellite payload may implement a regeneration of signals received from Earth. An NR-Uu radio interface may be associated with a service link between the satellite and the UE. An SRI may be associated with a feeder link between the NTN gateway and the satellite. The SRI may transport an F1 protocol. The NTN gateway may be a transport network layer node, and may support all necessary transport protocols. A DU onboard different satellites may be connected to the same CU on the ground. When the satellite hosts more than one DU, the same SRI may transport all of the corresponding F1 interface instances.

As indicated above, FIG. 6 is provided as an example. Other examples may differ from what is described with regard to FIG. 6.

Multiple NTN architectures (e.g., transparent satellite based NG-RAN architecture and/or regenerative satellite based NG-RAN architecture) may be installed and optimized on one satellite. Each NTN architecture may be associated with its own advantages and disadvantages (e.g., latency, satellite complexity, extendibility, and/or feeder link bandwidth). Several coexistence scenarios for the coexistence of different NTN architectures on one satellite may be defined. In a first scenario, one operator may deploy multiple NTN architectures on one satellite and optimize packet routing depending on services provided while keeping a satellite requirement on processing power and memory as low as possible. For example, a low latency service may be served by a gNB (or gNB-DU) processed payload architecture, and a delay tolerant service may be served by a bent-pipe architecture. The gNB (or gNB-DU) processed payload architecture may be associated with the regenerative satellite based NG-RAN architecture. The bent-pipe architecture may be associated with the transparent satellite based NG-RAN architecture. A gNB (or gNB-DU) processed payload architecture may serve various types of services, but may require higher satellite processing power and memories. In a second scenario, different operators may employ different NTN architectures depending on the service/deployment strategies. For example, some operators may deploy gNB (or gNB-DU) processed payload architecture(s) for an advanced user experience, while other operators may deploy a bent-pipe architecture for a simpler network implementation.

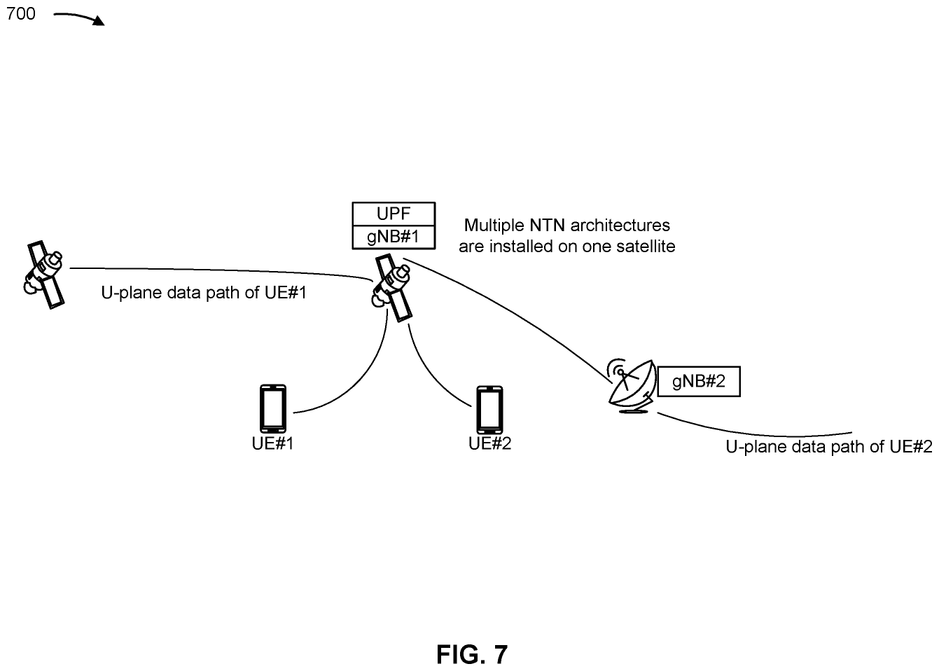

FIG. 7 is a diagram illustrating an example 700 of coexistence of different NTN architectures on a satellite, in accordance with the present disclosure.

As shown in FIG. 7, multiple NTN architectures may be installed on one satellite. For example, both a gNB (or gNB-DU) processed payload architecture and a bent-pipe architecture may be installed on the same satellite. A first network node (gNB #1) may be associated with a gNB processed payload with an onboard UPF. A second network node (gNB #2) may be associated with the bent-pipe architecture or the gNB (or gNB-DU) processed payload architecture. A first UE (UE #1) may be a UE connected to the gNB processed payload with the onboard UPF. The first UE may be associated with a low latency service. A user plane data path may be defined for the first UE. The second UE (UE #2) may be a UE connected to the second network node (e.g., via the gNB (or gNB-DU) processed payload architecture or via the bent-pipe architecture). A user plane data path may be defined for the second UE. The second UE may be associated with a delay tolerant service.

As indicated above, FIG. 7 is provided as an example. Other examples may differ from what is described with regard to FIG. 7.

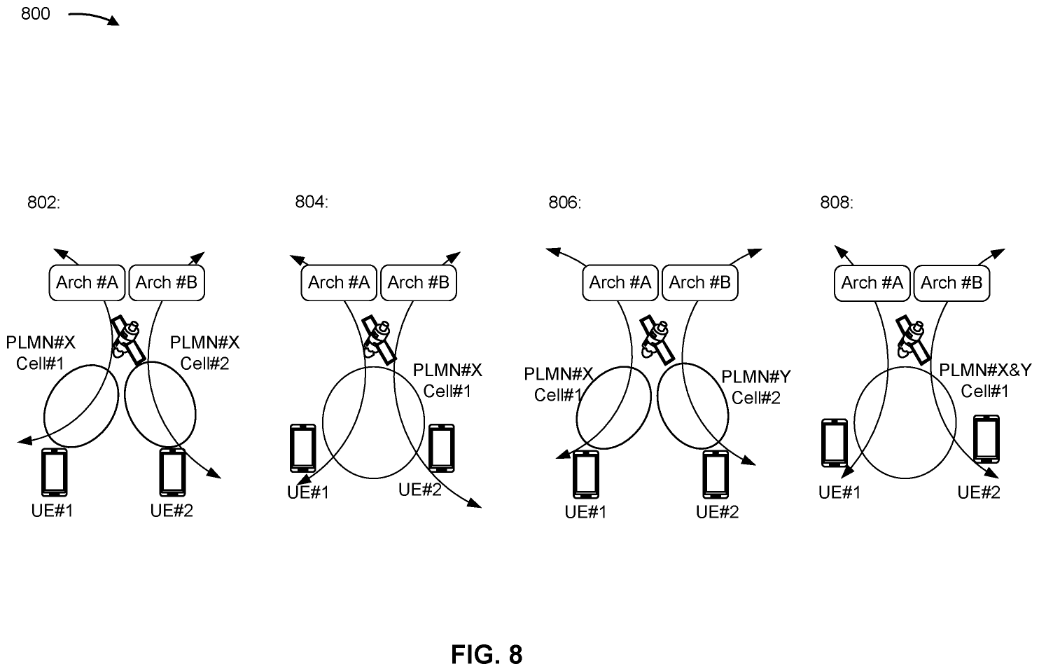

FIG. 8 is a diagram illustrating an example 800 of coexistence of multiple NTN architectures, in accordance with the present disclosure.

Four cases may be defined in terms of multiple/single cell and same/different public land mobile network (PLMN) for different NTN architectures. A same PLMN may include an equivalent PLMN. As shown by reference number 802, a first case may involve different NTN architectures (Arch #A and Arch #B) with multiple cells (Cell #1 and Cell #2) in a same PLMN (PLMN #X). As shown by reference number 804, a second case may involve different NTN architectures (Arch #A and Arch #B) with single cell(s) (Cell #1) in a same PLMN (PLMN #X). As shown by reference number 806, a third case may involve different NTN architectures (Arch #A and Arch #B) with multiple cells (Cell #1 and Cell #2) in different PLMNs (PLMN #X and PLMN #Y). As shown by reference number 808, a fourth case may involve different NTN architectures (Arch #A and Arch #B) with single cell(s) (Cell #1) in different PLMNs (PLMN #X&Y).

As indicated above, FIG. 8 is provided as an example. Other examples may differ from what is described with regard to FIG. 8.

When multiple NTN architectures coexist on a satellite, a UE may need to connect to a suitable NTN architecture. For example, when the UE requests a particular service using an ISL (e.g., store and forward), then the UE should connect to a gNB (or gNB-DU) processed payload architecture. On the other hand, when an onboard gNB, gNB-CU, and/or UPF is congested, the UE should connect to a bent-pipe architecture. Network handling may allow a network to change the gNB and/or the UPF for the UE via a handover or via a release with redirection. However, such network handling may take additional time to establish a connection with a suitable NTN architecture, which may be based at least in part on a longer OTA delay in an NTN environment as compared to a non-NTN environment. Thus, network handling in this scenario may degrade an overall system performance.

In various aspects of techniques and apparatuses described herein, a UE may receive cell characteristic information of multiple network nodes associated with different network architectures, such as NTN architectures. The UE may select a network node, from the multiple network nodes, based at least in part on a mapping rule and the cell characteristic information. The mapping rule may be associated with UE information and cell or network information. The UE may transmit, to the network node, a RACH message to establish a connection with the network node. Alternatively, a network node, such as a routing node, may receive a message from a UE. The network node may route, based at least in part on information associated with the message, the message to an upper layer node associated with a network architecture, such as an NTN architecture. As a result, the UE may be able to connect to a suitable NTN architecture. In other words, the UE may connect to a node (e.g., a network node or an upper layer node, such as a DU, CU, and/or CN) that is associated with the suitable NTN architecture, which may be useful when a satellite installs multiple NTN architectures. The node associated with the suitable NTN architecture may be selected by the UE itself or another node, such as the routing node. For example, the UE may connect to a node associated with a gNB (or gNB-DU) processed payload architecture or a node associated with a bent-pipe architecture, which may be based at least in part on a particular service used by other UE and/or other factors (e.g., congestion). The UE may be able to connect to the suitable NTN architecture without a network handling (e.g., changing a gNB and/or UPF via a handover or a release with redirection), which may improve an overall system performance.

FIG. 9 is a diagram illustrating an example 900 associated with coexistence of different NTN architectures on satellites, in accordance with the present disclosure. As shown in FIG. 9, example 900 includes communication between a UE (e.g., UE 120) and network node(s) (e.g., network node 110). In some aspects, the UE and the network node(s) may be included in a wireless network, such as wireless network 100.

As shown by reference number 902, the UE may receive cell characteristic information of multiple network nodes associated with different network architectures. The different NTN architectures may be associated with multiple cells in a same PLMN. In some aspects, the UE may receive the cell characteristic information via system information blocks (SIBs) associated with the multiple network nodes. For example, the UE may receive, from a first network node associated with a first NTN architecture, a first SIB indicating cell characteristic information associated with the first network node. The UE may receive, from a second network node associated with a second NTN architecture, a second SIB indicating cell characteristic information associated with the second network node.

As shown by reference number 904, the UE may select a network node, from the multiple network nodes, based at least in part on a mapping rule and the cell characteristic information. The mapping rule may be associated with UE information. The UE information may indicate a quality of service (QOS), a UE service type, a UE type, a UE state, a UE speed, a UE connection history, a UE capability, and/or a radio access technology (RAT). The mapping rule may be associated with cell or network information. The cell or network information may indicate an NTN architecture, an expected RAN delay, an expected QoS to be supported, a RAT, a radio quality, and/or an orbit type. The mapping rule may be configured by a network via a broadcast or a dedicated message, or the mapping rule may be preconfigured in a subscriber identification module (SIM) of the UE. The UE may select the network node based at least in part on the UE camping on a cell or attempting a connection establishment.

As shown by reference number 906, the UE may transmit, to the network node, a random access channel (RACH) message to establish a connection with the network node. The UE may transmit the RACH message to the network node selected based at least in part on the mapping rule and the cell characteristic information. The network node may be associated with one of the different NTN architectures.

As indicated above, FIG. 9 is provided as an example. Other examples may differ from what is described with regard to FIG. 9.

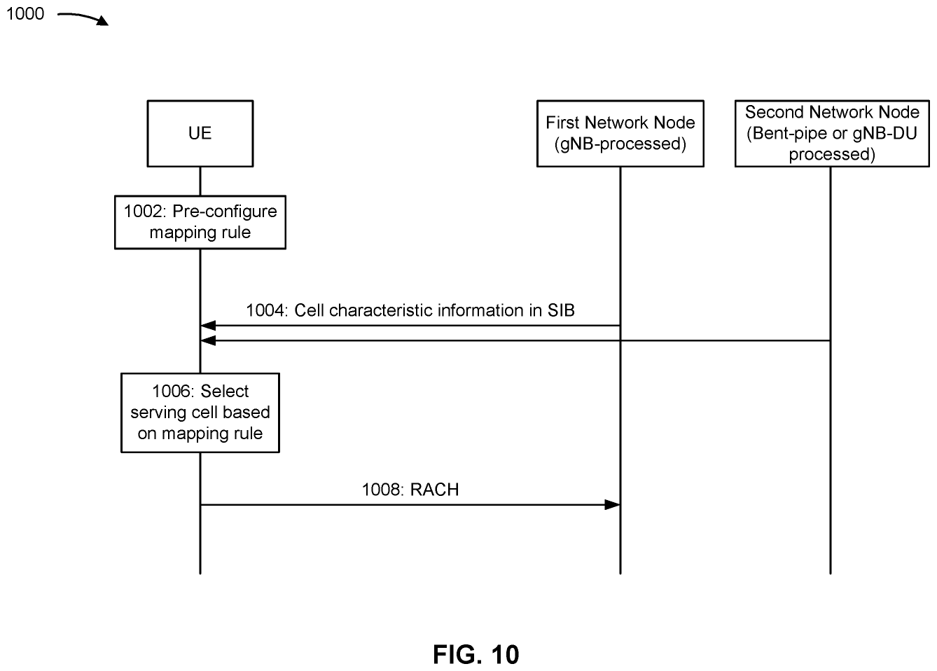

FIG. 10 is a diagram illustrating an example 1000 associated with coexistence of different NTN architectures on satellites, in accordance with the present disclosure. As shown in FIG. 10, example 1000 includes communication between a UE (e.g., UE 120), a first network node (e.g., network node 110a), and a second network node (e.g., network node 110b). In some aspects, the UE, the first network node, and the second network node may be included in a wireless network, such as wireless network 100.

In some aspects, the first network node may be associated with a gNB-processed payload architecture. The second network node may be associated with a bent-pipe architecture or a gNB-DU processed payload architecture. In other words, the first network node and the second network node may be associated with different network architectures. In some aspects, the different NTN architectures may be associated with multiple cells in the same PLMN. The multiple cells may be associated with the different NTN architectures, so the UE should be able to access a suitable cell. In other words, the UE should be able to access the first network node or the second network node. In some aspects, the UE may select the suitable cell to access (e.g., a suitable network node to access) based at least in part on UE information and characteristics of the network/cell.

As shown by reference number 1002, a UE may be preconfigured with a mapping rule. The UE may be preconfigured with the mapping rule of UE information and network/cell information. The UE information may indicate a QoS, a UE service type (e.g., voice centric or best effort centric), a UE type, a UE state (e.g., RRC idle or RRC inactive), a UE speed, a UE connection history, a UE capability, and/or a RAT. The network/cell information may indicate an NTN architecture (index), an expected RAN delay (e.g., a one-way delay or a round-trip-time (RTT) delay), a QoS expected to be supported, a RAT, a radio quality such as an RSRP, and/or an orbit type. The preconfigured mapping rule may be configured by the network (e.g., via broadcast information or a dedicated message). The preconfigured mapping rule may be preconfigured in a SIM and/or in the UE. When cells are associated with different timing advances (TAs), the UE may need to negotiate a camping cell/TA with a core network, such that the core network is aware of the cell on which the UE is camping. The UE may indicate a service interest message to the network.

As shown by reference number 1004, the first network node and/or the second network node may broadcast cell characteristic information in an SIB. The UE may receive the cell characteristic information broadcast by the first network node and/or the second network node. As shown by reference number 1006, the UE may select a serving cell based at least in part on the preconfigured mapping rule and/or the cell characteristic information. When the UE camps on a cell or attempts a connection establishment, the UE may select the suitable cell according to the preconfigured mapping rule and/or the cell characteristic information. As shown by reference number 1008, the UE may establish a connection with the first network node or the second network node. For example, the UE may transmit a RACH message to the first network node (e.g., as shown in FIG. 10) or the second network node to establish the connection.

As indicated above, FIG. 10 is provided as an example. Other examples may differ from what is described with regard to FIG. 10.

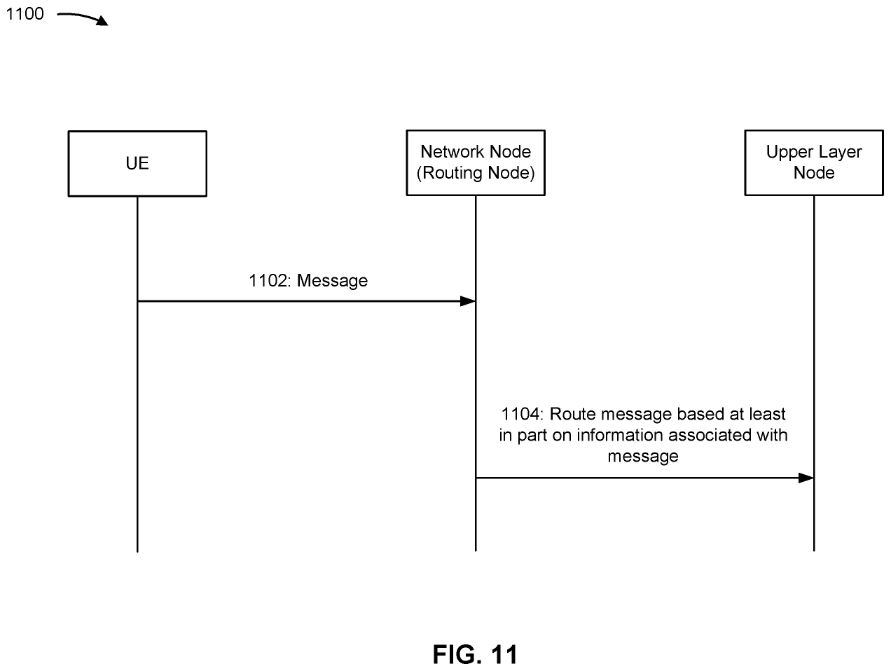

FIG. 11 is a diagram illustrating an example 1100 associated with coexistence of different NTN architectures on satellites, in accordance with the present disclosure. As shown in FIG. 11, example 1100 includes communication between a UE (e.g., UE 120), a network node (e.g., a routing node, such as network node 110a), and an upper layer node (e.g., network node 110b). In some aspects, the UE, the network node, and the upper layer node may be included in a wireless network, such as wireless network 100.

As shown by reference number 1102, the network node may receive a message from the UE. The message may be identified based at least in part on a specific uplink channel or signal, a specific time or frequency resource of an uplink transmission, a bandwidth part (BWP), a radio network temporary identifier (RNTI) a logical channel identifier (LCID), a bearer identifier, a flow identifier, a MAC control element (MAC CE), an RLC packet data unit (PDU), a PDCP PDU, an SDAP PDU, and/or an RRC message. In some aspects, the network node may receive the message from the UE based at least in part on a mapping rule configured for the UE. The mapping rule May be associated with UE information and the message. The mapping rule may be preconfigured in a SIM of the UE or configured via a broadcast or dedicated signaling.

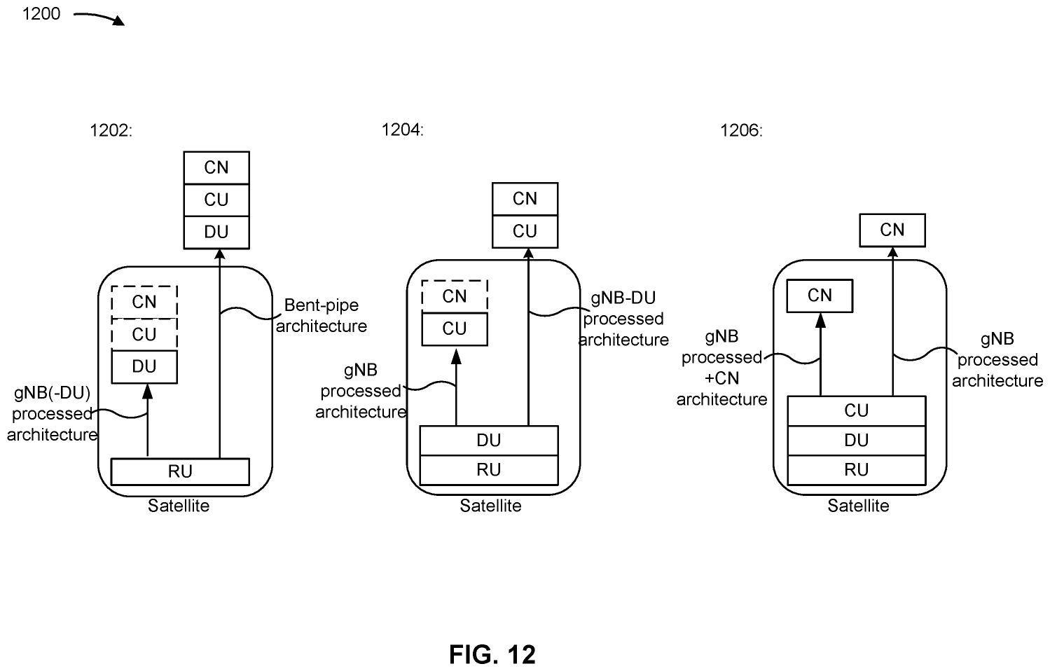

In some aspects, the network node may be a routing node. The routing node may be an RU, a DU, or a CU associated with the satellite (e.g., as shown in FIG. 12). The network node may be configured with a mapping rule associated with the message and the upper layer node. The mapping rule may be configured by the network node or the upper layer node, and the mapping rule may be changed semi-statically or dynamically based at least in part on a status of the upper layer node. The upper layer node may be identified by a node identifier and/or an endpoint identifier.

As shown by reference number 1104, the network node may route, based at least in part on information associated with the message, the message to the upper layer node associated with an NTN architecture. The NTN architecture may be one of different NTN architectures associated with a single cell in a same PLMN. In other words, the network node may route the message from the UE to a suitable upper layer node based at least in part on associated information. In some aspects, the network node may receive, from the upper layer node, an indication of a rejection of the message based at least in part on a status of the upper layer node. In this case, the network node may route the message to another upper layer node.

In some aspects, the NTN architecture may be one of different NTN architectures associated with multiple cells associated with different PLMNs. A home PLMN may be deprioritized in relation to other PLMNs depending on UE information and the NTN architecture. In some aspects, the NTN architecture may be one of different NTN architectures associated with a single cell associated with different PLMNs. A mapping rule may be configured per PLMN.

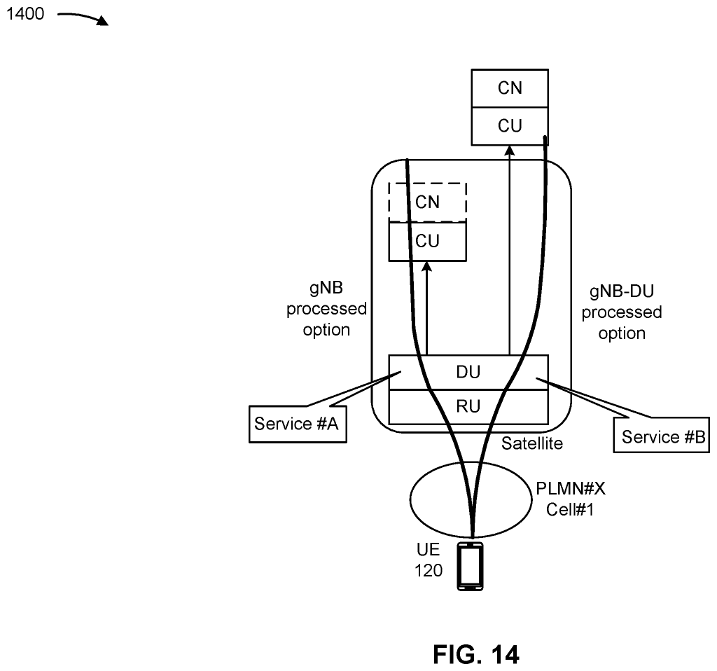

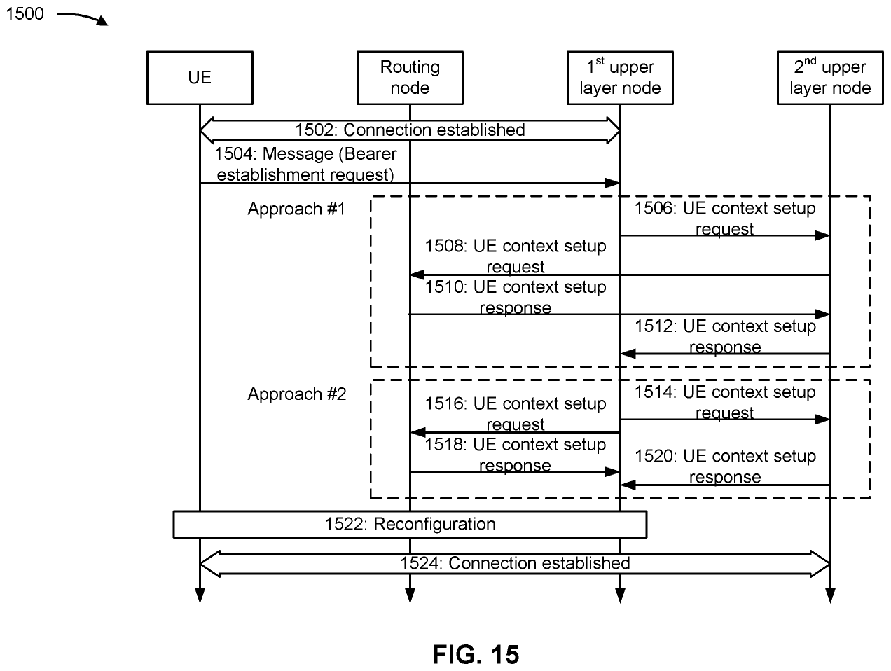

In some aspects, the UE may establish simultaneous connections to multiple NTN architectures (e.g., as shown in FIGS. 14 and 15). The UE may be associated with multiple services. First packets associated with a first service may be configured to be routed to a first upper layer node and second packets associated with a second service may be configured to be routed to a second upper layer node. In some aspects, the network node may receive a UE context setup request from a second upper layer node. The network node may transmit a UE context setup response to the second upper layer node. The UE may be reconfigured based at least in part on the UE context setup response, and a connection may be established between the UE and the second upper layer node based at least in part on a reconfiguration of the UE. In some aspects, the network node may receive a UE context setup request from the first upper layer node. The network node may transmit a UE context setup response to the first upper layer node. The UE may be reconfigured based at least in part on the UE context setup response, and a connection may be established between the UE and the second upper layer node based at least in part on a reconfiguration of the UE.

As indicated above, FIG. 11 is provided as an example. Other examples may differ from what is described with regard to FIG. 11.

FIG. 12 is a diagram illustrating an example 1200 associated with coexistence of different NTN architectures on satellites, in accordance with the present disclosure.

In some aspects, different NTN architectures may be associated with single cell(s) in the same PLMN. When multiple NTN architectures are operated on one cell, one of the gNB internal nodes (e.g., an RU, a DU, or a CU) may be a routing node to route a UE signal to a suitable gNB. Depending on the selected gNB internal node, different solutions may be applied.

As shown by reference number 1202, an RU of a satellite may be selected as a routing node. The RU may connect to a CN, a CU, and/or a DU based at least in part on a gNB (or gNB-DU) processed payload architecture. The RU may connect to a CN, a CU, and/or a DU (outside of the satellite) based at least in part on a bent-pipe architecture. The CU may be associated with a control plane and/or a user plane. The CN may be associated with an access and mobility management function (AMF) and/or a UPF.

As shown by reference number 1204, a DU of the satellite may be selected as a routing node. The DU may connect to a CN and/or a CU based at least in part on a gNB processed payload architecture. The DU may connect to a CN and/or a CU (outside of the satellite) based at least in part on a gNB-DU processed payload architecture.

As shown by reference number 1206, a CU of the satellite may be selected as a routing node. The CU may connect to a CN based at least in part on a processed payload and CN architecture. The CU may connect to a CN (outside of the satellite) based at least in part on a gNB processed payload architecture.

As indicated above, FIG. 12 is provided as an example. Other examples may differ from what is described with regard to FIG. 12.

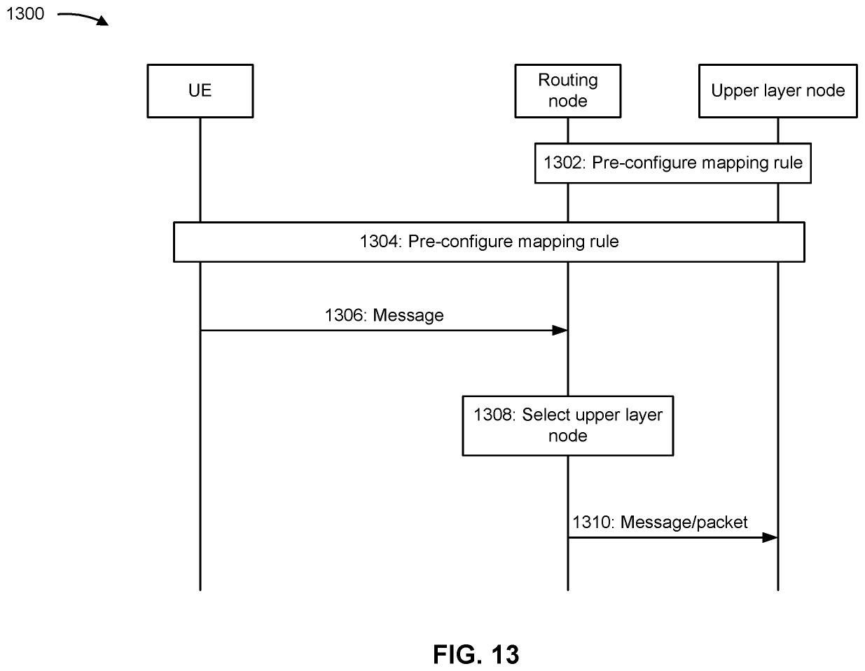

FIG. 13 is a diagram illustrating an example 1300 associated with coexistence of different NTN architectures on satellites, in accordance with the present disclosure. As shown in FIG. 13, example 1300 includes communication between a UE (e.g., UE 120), a routing node (e.g., network node 110a), and an upper layer node (e.g., network node 110b). In some aspects, the UE, the routing node, and the upper layer node may be included in a wireless network, such as wireless network 100.

In some aspects, the routing node may route a message/packet from the UE to suitable upper layer node(s) based at least in part on associated information. As shown by reference number 1302, the routing node may be configured with mapping rule(s) of a message from the UE and the upper layer node(s). The message may be identified by a specific uplink channel/signal (e.g., PRACH), a specific time/frequency resources of an uplink transmission, a BWP, an RNTI (e.g., an inactive RNTI (I-RNTI) or a cell RNTI (C-RNTI)), an LCID, a bearer identifier, a flow identifier, a MAC CE, an RLC PDU, a PDCP PDU, an SDAP PDU, and/or an RRC message. The upper layer node may be identified by a node identifier or an endpoint identifier (e.g., an Internet Protocol (IP) address or a tunnel endpoint identifier (TEID)). A mapping rule may be determined by the routing node or the upper layer node. The mapping rule may be changed semi-statically or dynamically based at least in part on an upper layer node status (e.g., congestion).

As shown by reference number 1304, the UE may be configured with mapping rule(s) of UE information and a message. The message may be identified by the specific uplink channel/signal (e.g., the PRACH), the specific time/frequency resources of the uplink transmission, the BWP, the RNTI (e.g., the I-RNTI or the C-RNTI), the LCID, the bearer identifier, the flow identifier, the MAC CE, the RLC PDU, the PDCP PDU, the SDAP PDU, and/or the RRC message. The UE information may be associated with a QoS, a UE type, a UE state (e.g., RRC idle or RRC inactive), a UE speed, a UE connection history, a UE capability, and/or a RAT. The mapping rule may be preconfigured in a UE/SIM, or the mapping rule may be configured via a broadcast or dedicated signaling.

As shown by reference number 1306, the UE may transmit a message to the routing node, where the routing node (or gNB) may be selected based at least in part on the preconfigured mapping rule. The message may have been configured when the UE was configured with the mapping rule(s) of the UE information and the message.

As shown by reference number 1308, the routing node may select an upper layer node to route the message/packet from the UE. As shown by reference number 1310, the routing node may transmit the message/packet to the selected upper layer node. The routing node may route the UE's message/packet to the upper layer node, which may be selected based at least in part on information associated with the message from the UE. The upper layer node may reject the message depending on the upper layer node status (e.g., when the upper layer node is congested). In this case, the routing node may route the message/packet from the UE to another upper layer node.

In some aspects, such signaling may be applicable when different NTN architectures are associated with multiple cells associated with different PLMNs. In some cases, a priority may be assigned among PLMNs. Since different operators may use different NTN architecture(s), an NTN architecture used in a home PLMN may not be suitable for a service while other NTN architectures may be suitable. In this case, other PLMNs may be prioritized over a home PLMN depending on UE information and the different NTN architectures. In some aspects, such signaling may be applicable when different NTN architectures are associated with single cell(s) in different PLMNs. Since one cell may support multiple PLMNs, mapping rule(s) may be configured per PLMN. For a PLMN selection, a priority among PLMNs may be considered.

In some aspects, such signaling may be defined for NTN scenarios. Alternatively, such signaling may be utilized for a CU-DU split in general (e.g., a CU-DU split in a terrestrial network).

As indicated above, FIG. 13 is provided as an example. Other examples may differ from what is described with regard to FIG. 13.

FIG. 14 is a diagram illustrating an example 1400 associated with coexistence of different NTN architectures on satellites, in accordance with the present disclosure.

As shown in FIG. 14, a DU of the satellite may be selected as a routing node. The DU may connect to a CN and/or a CU based at least in part on a gNB processed payload architecture. The DU may connect to a CN and/or a CU (outside of the satellite) based at least in part on a gNB-DU processed payload architecture. A UE 120 may connect to the satellite. The UE 120 may be associated with a certain cell and a certain PLMN. A first service of the UE 120 may be associated with the gNB processed payload architecture. A second service of the UE 120 may be associated with the gNB-DU processed payload architecture. Thus, the UE 120 may be associated with simultaneous connections to multiple NTN architectures.

In some aspects, when the UE 120 has multiple services, packets of the UE 120 may need to be routed to the corresponding suitable upper layer node respectively. In this case, the UE 120 may be connected to multiple user plane nodes in the network (e.g., a CU user plane and a UPF). A UE context may be managed in the network accordingly. A control plane made may control the UE 120 and a user plane node to establish a bearer for a service, which may be based at least in part on a utilization of a multi-RAT dual connectivity (MR-DC) (e.g., a secondary node (SN) terminated bearer) mechanism while using a single cell group for the bearers.

As indicated above, FIG. 14 is provided as an example. Other examples may differ from what is described with regard to FIG. 14.

FIG. 15 is a diagram illustrating an example 1500 associated with coexistence of different NTN architectures on satellites, in accordance with the present disclosure. As shown in FIG. 15, example 1500 includes communication between a UE (e.g., UE 120), a routing node (e.g., network node 110a), a first upper layer node (e.g., network node 110b), and a second upper layer node (e.g., network node 110c). In some aspects, the UE, the routing node, the first upper layer node, and the second upper layer node may be included in a wireless network, such as wireless network 100.

As shown by reference number 1502, the UE may be connected to the routing node and the first upper layer node. As shown by reference number 1504, the UE may transmit a message to the first upper layer node to establish an additional bearer, which may not be supported by an existing bearer/architecture. The message may be associated with a bearer establishment request.

In a first approach, as shown by reference number 1506, the first upper layer node may transmit a UE context setup request to the second upper layer node. As shown by reference number 1508, the second upper layer node may transmit the UE context setup request to the routing node. As shown by reference number 1510, the routing node may transmit a UE context setup response to the second upper layer node. As shown by reference number 1512, the second upper layer node may transmit the UE context setup response to the first upper layer node.

In a second approach, as shown by reference number 1514, the first upper layer node may transmit a UE context setup request to the second upper layer node. As shown by reference number 1516, the first upper layer node may transmit a UE context setup request to the routing node. As shown by reference number 1518, the routing node may transmit a UE context setup response to the first upper layer node. As shown by reference number 1520, the second upper layer node may transmit a UE context setup response to the first upper layer node.

As shown by reference number 1522, the UE may be reconfigured with a new configuration. As shown by reference number 1524, the UE may establish a connection with the second upper layer node based at least in part on the new configuration.

As indicated above, FIG. 15 is provided as an example. Other examples may differ from what is described with regard to FIG. 15.

FIG. 16 is a diagram illustrating an example process 1600 performed, for example, at a UE or an apparatus of a UE, in accordance with the present disclosure. Example process 1600 is an example where the apparatus or the UE (e.g., UE 120) performs operations associated with coexistence of different network architectures for a satellite.

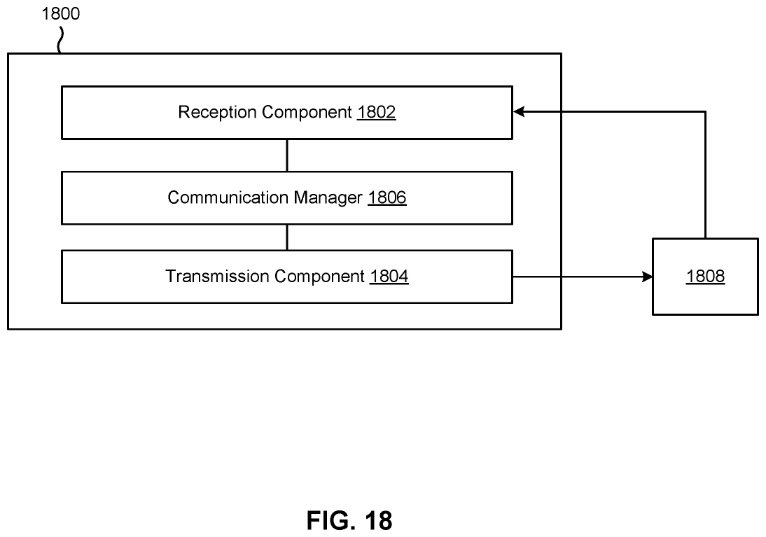

As shown in FIG. 16, in some aspects, process 1600 may include receiving cell characteristic information of multiple network nodes associated with different network architectures (block 1610). For example, the UE (e.g., using reception component 1802 and/or communication manager 1806, depicted in FIG. 18) may receive cell characteristic information of multiple network nodes associated with different network architectures, as described above in connection with FIGS. 9-15.

As further shown in FIG. 16, in some aspects, process 1600 may include selecting a network node, from the multiple network nodes, based at least in part on a mapping rule and the cell characteristic information, wherein the mapping rule is associated with UE information and cell or network information (block 1620). For example, the UE (e.g., using communication manager 1806, depicted in FIG. 18) may select a network node, from the multiple network nodes, based at least in part on a mapping rule and the cell characteristic information, wherein the mapping rule is associated with UE information and cell or network information, as described above in connection with FIGS. 9-15.

As further shown in FIG. 16, in some aspects, process 1600 may include transmitting a RACH message to establish a connection with the network node (block 1630). For example, the UE (e.g., using transmission component 1804 and/or communication manager 1806, depicted in FIG. 18) may transmit a RACH message to establish a connection with the network node, as described above in connection with FIGS. 9-15.

Process 1600 may include additional aspects, such as any single aspect or any combination of aspects described below and/or in connection with one or more other processes described elsewhere herein.

In a first aspect, the cell characteristic information is received via SIBs associated with the multiple network nodes.

In a second aspect, alone or in combination with the first aspect, the different network architectures are associated with multiple cells associated with a PLMN.

In a third aspect, alone or in combination with one or more of the first and second aspects, the UE information indicates one or more of a QoS, a UE service type, a UE type, a UE state, a UE speed, a UE connection history, a UE capability, and/or a RAT.

In a fourth aspect, alone or in combination with one or more of the first through third aspects, the cell or network information indicates one or more of an NTN architecture, an expected RAN delay, an expected QoS to be supported, a RAT, a radio quality, or an orbit type.

In a fifth aspect, alone or in combination with one or more of the first through fourth aspects, the mapping rule is configured by a network via a broadcast or a dedicated message, or the mapping rule is preconfigured in a SIM of the UE.

In a sixth aspect, alone or in combination with one or more of the first through fifth aspects, the network node is selected based at least in part on the UE camping on a cell or attempting a connection establishment.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, at a network node or an apparatus of a network node, in accordance with the present disclosure. Example process 1700 is an example where the apparatus or the network node (e.g., network node 110) performs operations associated with coexistence of different network architectures for a satellite.

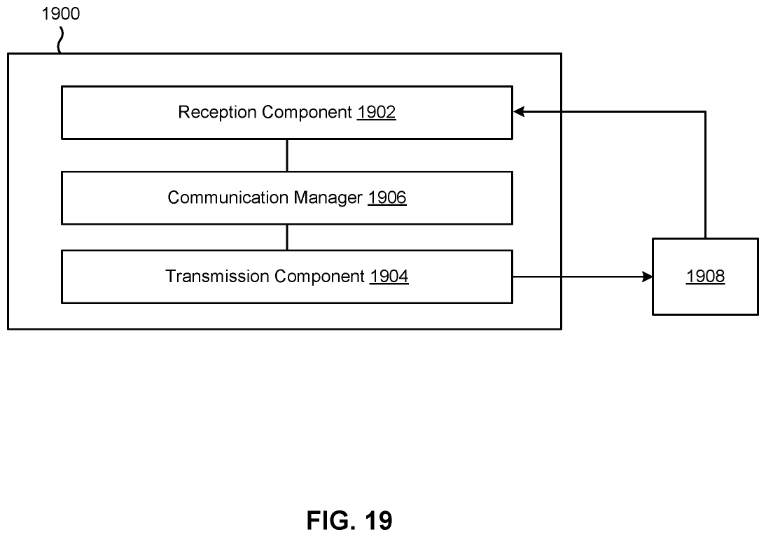

As shown in FIG. 17, in some aspects, process 1700 may include receiving, from a UE, a message (block 1710). For example, the network node (e.g., using reception component 1902 and/or communication manager 1906, depicted in FIG. 19) may receive, from a UE, a message, as described above in connection with FIGS. 9-15.

As further shown in FIG. 17, in some aspects, process 1700 may include routing, based at least in part on information associated with the message, the message to an upper layer node associated with a network architecture (block 1720). For example, the network node (e.g., using communication manager 1906, depicted in FIG. 19) may route, based at least in part on information associated with the message, the message to an upper layer node associated with a network architecture, as described above in connection with FIGS. 9-15.

Process 1700 may include additional aspects, such as any single aspect or any combination of aspects described below and/or in connection with one or more other processes described elsewhere herein.

In a first aspect, the network architecture is one of different NTN architectures associated with a single cell in a same PLMN.

In a second aspect, alone or in combination with the first aspect, the network node is a routing node, and the routing node is an RU, a DU, or a CU associated with the satellite.

In a third aspect, alone or in combination with one or more of the first and second aspects, the network node is configured with a mapping rule associated with the message and the upper layer node.

In a fourth aspect, alone or in combination with one or more of the first through third aspects, the mapping rule is configured by the network node or the upper layer node, and the mapping rule is changed semi-statically or dynamically based at least in part on a status of the upper layer node.

In a fifth aspect, alone or in combination with one or more of the first through fourth aspects, the message is identified based at least in part on one or more of a specific uplink channel or signal, a specific time or frequency resource of an uplink transmission, a BWP, an RNTI, an LCID, a bearer identifier, a flow identifier, a MAC CE, an RLC PDU, a PDCP PDU, an SDAP PDU, or an RRC message.

In a sixth aspect, alone or in combination with one or more of the first through fifth aspects, the upper layer node is identified by one or more of a node identifier, or an endpoint identifier.

In a seventh aspect, alone or in combination with one or more of the first through sixth aspects, the message is received from the UE based at least in part on a mapping rule configured for the UE, the mapping rule is associated with UE information and the message, and the mapping rule is preconfigured in a SIM of the UE or configured via a broadcast or dedicated signaling.

In an eighth aspect, alone or in combination with one or more of the first through seventh aspects, process 1700 includes receiving, from the upper layer node, an indication of a rejection of the message based at least in part on a status of the upper layer node, and routing the message to another upper layer node.

In a ninth aspect, alone or in combination with one or more of the first through eighth aspects, the network architecture is one of different NTN architectures associated with multiple cells associated with different PLMNs, and a home PLMN is deprioritized in relation to other PLMNs depending on UE information and the NTN architecture.

In a tenth aspect, alone or in combination with one or more of the first through ninth aspects, the network architecture is one of different NTN architectures associated with a single cell associated with different PLMNs, and a mapping rule is configured per PLMN.

In an eleventh aspect, alone or in combination with one or more of the first through tenth aspects, the UE establishes simultaneous connections to multiple NTN architectures, the UE is associated with multiple services, and first packets associated with a first service are configured to be routed to a first upper layer node and second packets associated with a second service are configured to be routed to a second upper layer node.

In a twelfth aspect, alone or in combination with one or more of the first through eleventh aspects, the upper layer node is a first upper layer node, and process 1700 includes receiving a UE context setup request from a second upper layer node, and transmitting a UE context setup response to the second upper layer node, wherein the UE is reconfigured based at least in part on the UE context setup response and a connection is established between the UE and the second upper layer node based at least in part on a reconfiguration of the UE.

In a thirteenth aspect, alone or in combination with one or more of the first through twelfth aspects, the upper layer node is a first upper layer node, and process 1700 includes receiving a UE context setup request from the first upper layer node, and transmitting a UE context setup response to the first upper layer node, wherein the UE is reconfigured based at least in part on the UE context setup response and a connection is established between the UE and a second upper layer node based at least in part on a reconfiguration of the UE.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication, in accordance with the present disclosure. The apparatus 1800 may be a UE, or a UE may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 140 described in connection with FIG. 1. As shown, the apparatus 1800 may communicate with another apparatus 1808, such as a UE or a network node (such as a CU, a DU, an RU, or a base station), using the reception component 1802 and the transmission component 1804.

In some aspects, the apparatus 1800 may be configured to perform one or more operations described herein in connection with FIGS. 9-15. Additionally, or alternatively, the apparatus 1800 may be configured to perform one or more processes described herein, such as process 1600 of FIG. 16. In some aspects, the apparatus 1800 and/or one or more components shown in FIG. 18 may include one or more components of the UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1804 may be co-located with the reception component 1802 in one or more transceivers.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

The reception component 1802 may receive cell characteristic information of multiple network nodes associated with different network architectures. The communication manager 1806 may select a network node, from the multiple network nodes, based at least in part on a mapping rule and the cell characteristic information, wherein the mapping rule is associated with UE information and cell or network information. The transmission component 1804 may transmit a RACH message to establish a connection with the network node.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication, in accordance with the present disclosure. The apparatus 1900 may be a network node, or a network node may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 150 described in connection with FIG. 1. As shown, the apparatus 1900 may communicate with another apparatus 1908, such as a UE or a network node (such as a CU, a DU, an RU, or a base station), using the reception component 1902 and the transmission component 1904.

In some aspects, the apparatus 1900 may be configured to perform one or more operations described herein in connection with FIGS. 9-15. Additionally, or alternatively, the apparatus 1900 may be configured to perform one or more processes described herein, such as process 1700 of FIG. 17. In some aspects, the apparatus 1900 and/or one or more components shown in FIG. 19 may include one or more components of the network node described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1902 and/or the transmission component 1904 may include or may be included in a network interface. The network interface may be configured to obtain and/or output signals for the apparatus 1900 via one or more communications links, such as a backhaul link, a midhaul link, and/or a fronthaul link.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1908. In some aspects, the transmission component 1904 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1904 may be co-located with the reception component 1902 in one or more transceivers.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

The reception component 1902 may receive, from a UE, a message. The communication manager 1906 may route, based at least in part on information associated with the message, the message to an upper layer node associated with a network architecture. The reception component 1902 may receive, from the upper layer node, an indication of a rejection of the message based at least in part on a status of the upper layer node. The communication manager 1906 may route the message to another upper layer node.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

The following provides an overview of some Aspects of the present disclosure:

Aspect 1: A method of wireless communication performed by a user equipment (UE), comprising: receiving cell characteristic information of multiple network nodes associated with different network architectures; selecting a network node, from the multiple network nodes, based at least in part on a mapping rule and the cell characteristic information, wherein the mapping rule is associated with UE information and cell or network information; and transmitting a random access channel (RACH) message to establish a connection with the network node.

Aspect 2: The method of Aspect 1, wherein the cell characteristic information is received via system information blocks (SIBs) associated with the multiple network nodes.

Aspect 3: The method of any of Aspects 1-2, wherein the different network architectures are associated with multiple cells associated with a public land mobile network (PLMN).

Aspect 4: The method of any of Aspects 1-3, wherein the UE information indicates one or more of: a quality of service (Qos), a UE service type, a UE type, a UE state, a UE speed, a UE connection history, a UE capability, and/or a radio access technology (RAT).

Aspect 5: The method of any of Aspects 1-4, wherein the cell or network information indicates one or more of: a non-terrestrial network (NTN) architecture, an expected radio access network (RAN) delay, an expected quality of service (QoS) to be supported, a radio access technology (RAT), a radio quality, or an orbit type.

Aspect 6: The method of any of Aspects 1-5, wherein the mapping rule is configured by a network via a broadcast or a dedicated message, or the mapping rule is preconfigured in a subscriber identification module (SIM) of the UE.

Aspect 7: The method of any of Aspects 1-6, wherein the network node is selected based at least in part on the UE camping on a cell or attempting a connection establishment.

Aspect 8: A method of wireless communication performed by a network node associated with a satellite, comprising: receiving, from a user equipment (UE), a message; and routing, based at least in part on information associated with the message, the message to an upper layer node associated with a network architecture.

Aspect 9: The method of Aspect 8, wherein the network architecture is one of different non-terrestrial network (NTN) architectures associated with a single cell in a same public land mobile network (PLMN).

Aspect 10: The method of any of Aspects 8-9, wherein the network node is a routing node, and the routing node is a radio unit (RU), a distributed unit (DU), or a central unit (CU) associated with the satellite.

Aspect 11: The method of any of Aspects 8-10, wherein the network node is configured with a mapping rule associated with the message and the upper layer node.

Aspect 12: The method of Aspect 11, wherein the mapping rule is configured by the network node or the upper layer node, and the mapping rule is changed semi-statically or dynamically based at least in part on a status of the upper layer node.

Aspect 13: The method of any of Aspects 8-12, wherein the message is identified based at least in part on one or more of: a specific uplink channel or signal, a specific time or frequency resource of an uplink transmission, a bandwidth part (BWP), a radio network temporary identifier (RNTI), a logical channel identifier (LCID), a bearer identifier, a flow identifier, a medium access control control element (MAC CE), a radio link control (RLC) packet data unit (PDU), a packet data convergence protocol (PDCP) PDU, a service data adaptation protocol (SDAP) PDU, or a radio resource control (RRC) message.

Aspect 14: The method of any of Aspects 8-13, wherein the upper layer node is identified by one or more of: a node identifier, or an endpoint identifier.

Aspect 15: The method of any of Aspects 8-14, wherein the message is received from the UE based at least in part on a mapping rule configured for the UE, the mapping rule is associated with UE information and the message, and the mapping rule is preconfigured in a subscriber identification module (SIM) of the UE or configured via a broadcast or dedicated signaling.

Aspect 16: The method of any of Aspects 8-15, further comprising: receiving, from the upper layer node, an indication of a rejection of the message based at least in part on a status of the upper layer node; and routing the message to another upper layer node.

Aspect 17: The method of any of Aspects 8-16, wherein the network architecture is one of different non-terrestrial network (NTN) architectures associated with multiple cells associated with different public land mobile networks (PLMNs), and a home PLMN is deprioritized in relation to other PLMNs depending on UE information and the NTN architecture.

Aspect 18: The method of any of Aspects 8-17, wherein the network architecture is one of different non-terrestrial network (NTN) architectures associated with a single cell associated with different public land mobile networks (PLMNs), and a mapping rule is configured per PLMN.

Aspect 19: The method of any of Aspects 8-18, wherein the UE establishes simultaneous connections to multiple non-terrestrial network (NTN) architectures, the UE is associated with multiple services, and first packets associated with a first service are configured to be routed to a first upper layer node and second packets associated with a second service are configured to be routed to a second upper layer node.

Aspect 20: The method of any of Aspects 8-19, wherein the upper layer node is a first upper layer node, and further comprising: receiving a UE context setup request from a second upper layer node; and transmitting a UE context setup response to the second upper layer node, wherein the UE is reconfigured based at least in part on the UE context setup response and a connection is established between the UE and the second upper layer node based at least in part on a reconfiguration of the UE.

Aspect 21: The method of any of Aspects 8-20, wherein the upper layer node is a first upper layer node, and further comprising: receiving a UE context setup request from the first upper layer node; and transmitting a UE context setup response to the first upper layer node, wherein the UE is reconfigured based at least in part on the UE context setup response and a connection is established between the UE and a second upper layer node based at least in part on a reconfiguration of the UE.

Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-7.

Aspect 23: An apparatus for wireless communication at a device, the apparatus comprising one or more memories and one or more processors coupled to the one or more memories, the one or more processors configured to cause the device to perform the method of one or more of Aspects 1-7.

Aspect 24: An apparatus for wireless communication, the apparatus comprising at least one means for performing the method of one or more of Aspects 1-7.

Aspect 25: A non-transitory computer-readable medium storing code for wireless communication, the code comprising instructions executable by one or more processors to perform the method of one or more of Aspects 1-7.

Aspect 26: A non-transitory computer-readable medium storing a set of instructions for wireless communication, the set of instructions comprising one or more instructions that, when executed by one or more processors of a device, cause the device to perform the method of one or more of Aspects 1-7.

Aspect 27: A device for wireless communication, the device comprising a processing system that includes one or more processors and one or more memories coupled with the one or more processors, the processing system configured to cause the device to perform the method of one or more of Aspects 1-7.

Aspect 28: An apparatus for wireless communication at a device, the apparatus comprising one or more memories and one or more processors coupled to the one or more memories, the one or more processors individually or collectively configured to cause the device to perform the method of one or more of Aspects 1-7.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 8-21.

Aspect 30: An apparatus for wireless communication at a device, the apparatus comprising one or more memories and one or more processors coupled to the one or more memories, the one or more processors configured to cause the device to perform the method of one or more of Aspects 8-21.

Aspect 31: An apparatus for wireless communication, the apparatus comprising at least one means for performing the method of one or more of Aspects 8-21.

Aspect 32: A non-transitory computer-readable medium storing code for wireless communication, the code comprising instructions executable by one or more processors to perform the method of one or more of Aspects 8-21.

Aspect 33: A non-transitory computer-readable medium storing a set of instructions for wireless communication, the set of instructions comprising one or more instructions that, when executed by one or more processors of a device, cause the device to perform the method of one or more of Aspects 8-21.

Aspect 34: A device for wireless communication, the device comprising a processing system that includes one or more processors and one or more memories coupled with the one or more processors, the processing system configured to cause the device to perform the method of one or more of Aspects 8-21.

Aspect 35: An apparatus for wireless communication at a device, the apparatus comprising one or more memories and one or more processors coupled to the one or more memories, the one or more processors individually or collectively configured to cause the device to perform the method of one or more of Aspects 8-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
memory; and
one or more processors coupled to the memory, the one or more processors configured to cause the UE to:
receive cell characteristic information of multiple network nodes associated with different network architectures;
select a network node, from the multiple network nodes, based at least in part on a mapping rule and the cell characteristic information, wherein the mapping rule is associated with UE information and cell or network information; and
transmit a random access channel (RACH) message to establish a connection with the network node.

2. The apparatus of claim 1, wherein the cell characteristic information is received via system information blocks (SIBs) associated with the multiple network nodes.

3. The apparatus of claim 1, wherein the different network architectures are associated with multiple cells associated with a public land mobile network (PLMN).

4. The apparatus of claim 1, wherein the UE information indicates one or more of: a quality of service (QOS), a UE service type, a UE type, a UE state, a UE speed, a UE connection history, a UE capability, or a radio access technology (RAT).

5. The apparatus of claim 1, wherein the cell or network information indicates one or more of: a non-terrestrial network (NTN) architecture, an expected radio access network (RAN) delay, an expected quality of service (QOS) to be supported, a radio access technology (RAT), a radio quality, or an orbit type.

6. The apparatus of claim 1, wherein the mapping rule is configured by a network via a broadcast or a dedicated message, or the mapping rule is preconfigured in a subscriber identification module (SIM) of the UE.

7. The apparatus of claim 1, wherein the network node is selected based at least in part on the UE camping on a cell or attempting a connection establishment.

8. An apparatus for wireless communication at a network node associated with a satellite, comprising:
memory; and
one or more processors coupled to the memory, the one or more processors configured to cause the network node to:
receive, from a user equipment (UE), a message; and
route, based at least in part on information associated with the message, the message to an upper layer node associated with a network architecture.

9. The apparatus of claim 8, wherein the network architecture is one of different non-terrestrial network (NTN) architectures associated with a single cell in a same public land mobile network (PLMN).

10. The apparatus of claim 8, wherein the network node is a routing node, and the routing node is a radio unit (RU), a distributed unit (DU), or a central unit (CU) associated with the satellite.

11. The apparatus of claim 8, wherein the network node is configured with a mapping rule associated with the message and the upper layer node.

12. The apparatus of claim 11, wherein the mapping rule is configured by the network node or the upper layer node, and the mapping rule is changed semi-statically or dynamically based at least in part on a status of the upper layer node.

13. The apparatus of claim 8, wherein the message is identified based at least in part on one or more of: a specific uplink channel or signal, a specific time or frequency resource of an uplink transmission, a bandwidth part (BWP), a radio network temporary identifier (RNTI), a logical channel identifier (LCID), a bearer identifier, a flow identifier, a medium access control control element (MAC CE), a radio link control (RLC) packet data unit (PDU), a packet data convergence protocol (PDCP) PDU, a service data adaptation protocol (SDAP) PDU, or a radio resource control (RRC) message.

14. The apparatus of claim 8, wherein the upper layer node is identified by one or more of: a node identifier, or an endpoint identifier.

15. The apparatus of claim 8, wherein the message is received from the UE based at least in part on a mapping rule configured for the UE, the mapping rule is associated with UE information and the message, and the mapping rule is preconfigured in a subscriber identification module (SIM) of the UE or configured via a broadcast or dedicated signaling.

16. The apparatus of claim 8, wherein the one or more processors are further configured to cause the network node to:
receive, from the upper layer node, an indication of a rejection of the message based at least in part on a status of the upper layer node; and
route the message to another upper layer node.

17. The apparatus of claim 8, wherein the network architecture is one of different non-terrestrial network (NTN) architectures associated with multiple cells associated with different public land mobile networks (PLMNs), and a home PLMN is deprioritized in relation to other PLMNs depending on UE information and the NTN architecture.

18. The apparatus of claim 8, wherein the network architecture is one of different non-terrestrial network (NTN) architectures associated with a single cell associated with different public land mobile networks (PLMNs), and a mapping rule is configured per PLMN.

19. The apparatus of claim 8, wherein the UE establishes simultaneous connections to multiple non-terrestrial network (NTN) architectures, the UE is associated with multiple services, and first packets associated with a first service are configured to be routed to a first upper layer node and second packets associated with a second service are configured to be routed to a second upper layer node.

20. The apparatus of claim 8, wherein the upper layer node is a first upper layer node, and the one or more processors are further configured to cause the network node to:
receive a UE context setup request from a second upper layer node; and
transmit a UE context setup response to the second upper layer node,
wherein the UE is reconfigured based at least in part on the UE context setup response and a connection is established between the UE and the second upper layer node based at least in part on a reconfiguration of the UE.

21. The apparatus of claim 8, wherein the upper layer node is a first upper layer node, and the one or more processors are further configured to cause the network node to:
receive a UE context setup request from the first upper layer node; and
transmit a UE context setup response to the first upper layer node,
wherein the UE is reconfigured based at least in part on the UE context setup response and a connection is established between the UE and a second upper layer node based at least in part on a reconfiguration of the UE.

22. A method of wireless communication performed by a user equipment (UE), comprising:
receiving cell characteristic information of multiple network nodes associated with different network architectures;
selecting a network node, from the multiple network nodes, based at least in part on a mapping rule and the cell characteristic information, wherein the mapping rule is associated with UE information and cell or network information; and
transmitting a random access channel (RACH) message to establish a connection with the network node.

23. The method of claim 22, wherein:
the cell characteristic information is received via system information blocks (SIBs) associated with the multiple network nodes; and
the different network architectures are associated with multiple cells associated with a public land mobile network (PLMN).

24. The method of claim 22, wherein:
the UE information indicates one or more of: a quality of service (QOS), a UE service type, a UE type, a UE state, a UE speed, a UE connection history, a UE capability, or a radio access technology (RAT); and
the cell or network information indicates one or more of: a non-terrestrial network (NTN) architecture, an expected radio access network (RAN) delay, an expected QoS to be supported, the RAT, a radio quality, or an orbit type.

25. The method of claim 22, wherein:
the mapping rule is configured by a network via a broadcast or a dedicated message, or the mapping rule is preconfigured in a subscriber identification module (SIM) of the UE; or
the network node is selected based at least in part on the UE camping on a cell or attempting a connection establishment.

26. A method of wireless communication performed by a network node associated with a satellite, comprising:
receiving, from a user equipment (UE), a message; and
routing, based at least in part on information associated with the message, the message to an upper layer node associated with a network architecture.

27. The method of claim 26, wherein:
the network architecture is one of different non-terrestrial network (NTN) architectures associated with a single cell associated with a same public land mobile network (PLMN);
the network architecture is one of different NTN architectures associated with multiple cells associated with different public land mobile networks (PLMNs), and a home PLMN is deprioritized in relation to other PLMNs depending on UE information and the NTN architecture; or
the network architecture is one of different NTN architectures associated with a single cell associated with different public land mobile networks (PLMNs), and a mapping rule is configured per PLMN.

28. The method of claim 26, wherein:
the network node is a routing node, and the routing node is a radio unit (RU), a distributed unit (DU), or a central unit (CU) associated with the satellite; or
the network node is configured with a mapping rule associated with the message and the upper layer node, the mapping rule is configured by the network node or the upper layer node, and the mapping rule is changed semi-statically or dynamically based at least in part on a status of the upper layer node.

29. The method of claim 26, wherein:
the message is identified based at least in part on one or more of: a specific uplink channel or signal, a specific time or frequency resource of an uplink transmission, a bandwidth part (BWP), a radio network temporary identifier (RNTI), a logical channel identifier (LCID), a bearer identifier, a flow identifier, a medium access control control element (MAC CE), a radio link control (RLC) packet data unit (PDU), a packet data convergence protocol (PDCP) PDU, a service data adaptation protocol (SDAP) PDU, or a radio resource control (RRC) message;
the upper layer node is identified by one or more of: a node identifier, or an endpoint identifier; or
the message is received from the UE based at least in part on a mapping rule configured for the UE, the mapping rule is associated with UE information and the message, and the mapping rule is preconfigured in a subscriber identification module (SIM) of the UE or configured via a broadcast or dedicated signaling.

30. The method of claim 26, further comprising:
receiving, from the upper layer node, an indication of a rejection of the message based at least in part on a status of the upper layer node; and
routing the message to another upper layer node.
